(19) United States
(12) Patent Application Publication
(10) Pub. No.: US 2014/0332308 A1
(43) Pub. Date: Nov. 13, 2014

(54) POWER STEERING ASSEMBLY WITH DIFFERENTIAL ANGLE SENSOR SYSTEM

(71) Applicant: TEDRIVE STEERING SYSTEMS GMBH, Wulfrath (DE)

(72) Inventors: Sven Kirschbaum, Mettmann (DE); Jens-Hauke Muller, Velbert-Neviges (DE)

(21) Appl. No.: 14/361,607

(22) PCT Filed: Jan. 7, 2013
(86) PCT No.: PCT/EP2013/050162

§ 371 Date: May 29, 2014

(30) Foreign Application Priority Data
Jan. 10, 2012 (DE) 10 2012 100 133.2
Aug. 7, 2012 (DE) 10 2012 107 211.6

(51) Int. Cl. B62D 6/10; B62D 5/083

(52) U.S. Cl. CPC B62D 6/10; B62D 5/0835
USPC 180/421

(57) ABSTRACT

A power steering assembly having an input shaft for connection to a steering wheel, an output shaft coupled to the input shaft for operational engagement with a steering rod, a servo controller, an actuator, a sensor system, and an evaluation unit for evaluating measurement values provided by the sensor system. The coupling between input and output shafts permits a relative rotation therebetween. The servo controller has a rotatable final control element with and driven by the output shaft. The steering force assistance is controlled depending on relative rotation between the input shaft and control element. The engagement between the output shaft and control element provides a relative displacement therebetween. The actuator relatively displaces the control element in relation to the output shaft. The sensor system measures at least one differential angle between the control element and output shaft or between the control element and input shaft.

### FIELD

The present disclosure relates to a power steering assembly for a power steering system, in particular for a hydraulic power steering system, of motor vehicles and to a corresponding use.

### BACKGROUND

Among other things, power steering assemblies for hydraulic power steering systems of vehicles comprise servo valves also known as rotary servo valves. They control the hydraulic pressure and thus the steering assistance depending on the steering torque applied by the driver. Most frequently, rotary servo valves are used in which an input shaft connected via a steering column with a steering wheel rotates relative to a valve portion (also referred to as control element, control sleeve or sleeve), which is connected to the output shaft and, in rack-and-pinion steering systems, with a steering pinion (also referred to as pinion). A torque-dependent adjustment of the control element of the servo valve, and thus torque-dependent valve characteristics and therefore steering power assistance characteristics, are realized through a torsion system between the input shaft and the control element.

In order to realize various further functions of a torque adjuster, for example a lane departure assistant, over- or understeering assistant, tactile feedback, variable steering assistance, for instance dependent on the vehicle speed or load, city mode, parking pilot, steering torque superposition, an adjustment of the position of the control element independent from the applied torque for the purpose of influencing the steering power assistance characteristics of the servo valve is known.

Such a servo steering valve is described, for example, in the published patent application DE 10 2004 049 686 A1. Here, the adjustment of the steering power assistance characteristics is achieved by adjusting the relative angle between the control element and an output shaft of the servo valve.

### SUMMARY

A need exists for further developing the power steering assembly of the type mentioned at the beginning such that its function can be better monitored in order to enhance driving safety and/or improve control of the steering power assistance system.

The power steering assembly according to the disclosure for a power steering system of motor vehicles comprises an input shaft for connection to a steering wheel, an output shaft which is coupled to the input shaft for operational engagement with a steering rod, the coupling between the input shaft and the output shaft permitting a relative rotation between them. According to the disclosure, a servo controller, preferably a hydraulic servo valve, is also provided which has a rotatable control element that is in engagement with and driven by the output shaft, the steering power assistance system being controlled depending on the relative rotation between the input shaft and the control element. According to the disclosure, the engagement between the output shaft and the control element provides for a relative displacement between the output shaft and the control element. Further, an actuator, for example an electromotive or electromagnetic actuator, is provided according to the disclosure for relatively displacing the control element in relation to the output shaft in order to influence the steering power assistance characteristics.

The power steering assembly according to the disclosure further comprises a sensor system for measuring at least one differential angle between the control element and the output shaft or between the control element and the input shaft. Moreover, an evaluation unit is provided for evaluating the measurement values provided by the sensor system. Advantageously, the provided data serve for monitoring the function and safety of the servo assembly.

The purpose of the disclosure is to obtain, in a steering system with a control element that is rotatable relative to the output shaft in order to influence the steering assistance system, important information from a fail-safe and control engineering standpoint. The insertion of a second elasticity (T-bar) between the input shaft and the output shaft for the relative rotation in the steering line, which would be required for a conventional torque sensor, can be omitted, accompanied by the advantage that the steering feel would otherwise be adversely affected.

Owing to the position of the sensor system on the steering gear close to the steering gear, the angle of rotation can be measured directly between the input shaft and the control element. In the generic servo assembly, the rotation can be caused either by the driver and/or by the actuator. In the case that the actuator and the driver simultaneously act on the control element and cause a displacement, this information can be reconstructed by calculation and the pure driver information can be determined by knowing the displacement distance of the actuator. For fail-safe reasons, this is important information in order to determine whether the driver is in contact with the steering wheel.

Moreover, the vehicle manufacturer can dispense with the integration of a steering angle sensor close to the steering wheel into the steering column. This saves construction space, costs and weight of the vehicle.

The full functional capability of the actuator-operated relative displacement of the control element in relation to the output shaft can be tested in the form of a system self test prior to the start of the journey. As long as the driver has not yet started the engine and steering assistance by the pump is not yet provided, the actuator can test the full functional capability of the system by rotating the control element over its entire displacement distance, for example up to the respective stop.

It is possible, for example, to derive therefrom the neutral position relative to the change of the steering power characteristics that can be caused by the displacement mechanism, for example the middle position thereof, and to check whether the system has become misaligned since the last journey or journeys, for example by data stored in the EEPROM with the currently determined ones.

As long as the actuator is in the neutral position during driving, conclusions can be drawn from the differential angle as to the steering torque set by the driver. Furthermore, it is possible to determine an offset of the system in the long run. As a rule, the signal of the sensor system should be compared to other signals available in the vehicle. For example, it is possible to determine different driving situations (e.g. straight driving) by comparing the wheel speeds, measuring the transverse acceleration or determining the yaw rate. In that case, the balancing of the control element to the neutral position could be readjusted, so that a torque-neutral steering is possible for the driver in the case of straight driving, depending on the situation.

Moreover, it would be possible to determine, by means of minute control steps of the actuator, the mechanical displacement hysteresis/play. Since the sensor system has a very small resolution, these control steps cannot be resolved by the driver, but the mechanical hysteresis information can be implemented into the control strategy, for example through manufacturing tolerances. In a next step, the increase of the play can then be determined from the above function via the lifetime of the system, for example through the wear, and can also be compensated.

With that knowledge, it is possible during a steering process to determine, by the driver and the simultaneous setting of the control element by the actuator, whether the desired additional displacement was actually set. It is also possible to additionally derive therefrom whether the driver is still in contact with the steering wheel at all. If that is not the case, then the control element, for example the valve sleeve, must be rotated into the neutral position via the actuator, because an inadvertent steering process would otherwise be initiated through the actuator, and the vehicle would leave the desired trajectory.

As long as the driver steers with simultaneous superposition, the steering torque set by the driver can inversely also be determined therefrom by difference calculation, of course.

In principle, the assembly according to the disclosure can be combined with any steering gear between the output shaft and the steering rod or steering shaft, with a rack-and-pinion gear or a recirculating ball steering gear being preferred. The terms steering rod and steering shaft are to be interpreted as synonyms and depend on the type of steering gear used in each case. A recirculating ball steering gear—the steering system is in that case also referred to as block steering system—is used with preference in the utility vehicle area, particularly in combination with a hydraulic servo valve.

According to another advantageous embodiment, the actuator is a stepping motor. Thus, an encoder on the motor, for example, for measuring the set relative displacement can be dispensed with. Based on the requested steps and the translation of the control gear, a prognosis can be made with a stepping motor on the expected relative displacement for the control element, for example the valve sleeve. Furthermore, by comparing the information from the stepping motor and the sensor system, it is possible to check whether the desired request was made or whether there is a control error in the form of too little, too much, or inadvertent.

Preferably, the engagement between the output shaft and the control element comprises a multi-stage planetary gear unit.

Preferably, the servo valve and the sensor system are accommodated in a valve tower of the steering-gear housing, or the sensor system can at least be attached to the valve tower of the steering-gear housing.

Preferably, the control element is a valve sleeve disposed coaxially with the input and the output shaft.

The sensor system preferably comprises a differential angle sensor or at least two angle sensors. These are preferably non-contact sensors, such as optical, inductive or magnetic sensors. More preferably, these are sensors with permanent-magnetic encoders or inductive sensors.

According to a preferred embodiment, the sensor system comprises an encoder sleeve non-rotatably connected to the valve sleeve.

### BRIEF DESCRIPTION OF THE FIGURES

FIG. 1: shows a sectional view along the longitudinal axis of a first embodiment of the power steering assembly according to the disclosure;

FIG. 2: shows a cross-sectional view of a second embodiment; and

FIG. 3: shows a cross-sectional view of a third embodiment.

### DETAILED DESCRIPTION OF THE FIGURES

The differential angle sensor 20 is pushed over the input shaft 21 and attached to the housing above the valve tower 22. The main component of the differential angle sensor 20 is non-rotatably connected to the input shaft 21, and the magnet 23, by means of a bushing that is non-rotatably connected to the valve sleeve 24 as a control element, leads the angle of rotation of the sleeve 24 out from the hydraulic region of the valve tower. The third part 25 of the sensor 20 is stationarily connected to the valve tower 22 and provides the differential angle information concerning the differential angle between the input shaft 21 and the valve sleeve 24 to the evaluation unit, which is not shown, via a connector or the like.

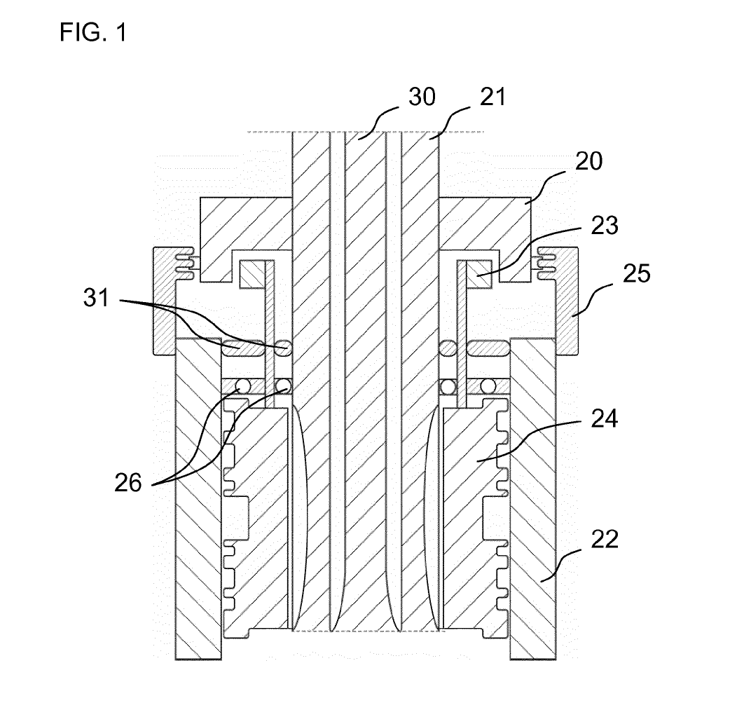

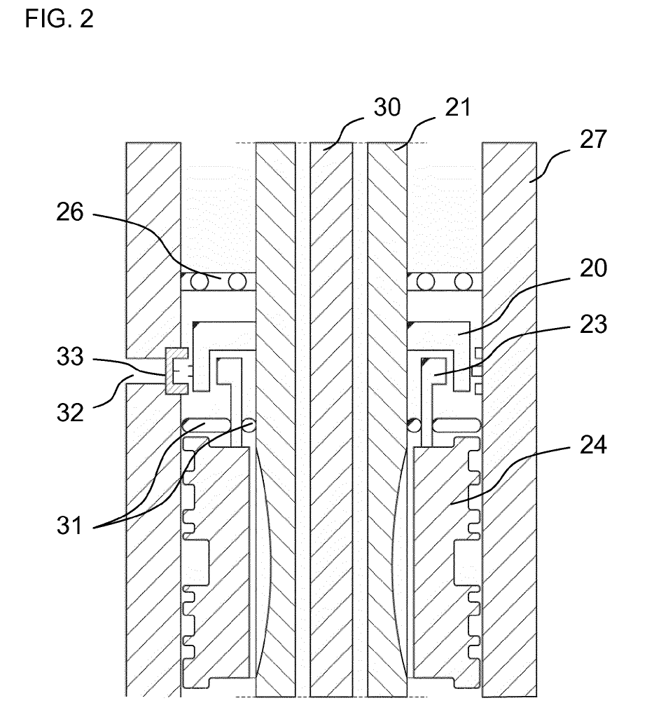

In the embodiment according to FIG. 1, the bearing (which is normally provided, as a rule, in hydraulic steering systems) comprises two concentrically disposed ball bearings 26 in order to center the input shaft 21 in the valve tower 22 and to compensate axial forces. The embodiment according to FIG. 2 shows a variation thereof. The valve tower 27 is made longer and the above-mentioned centering bearing 26 is installed above the sensor 20.

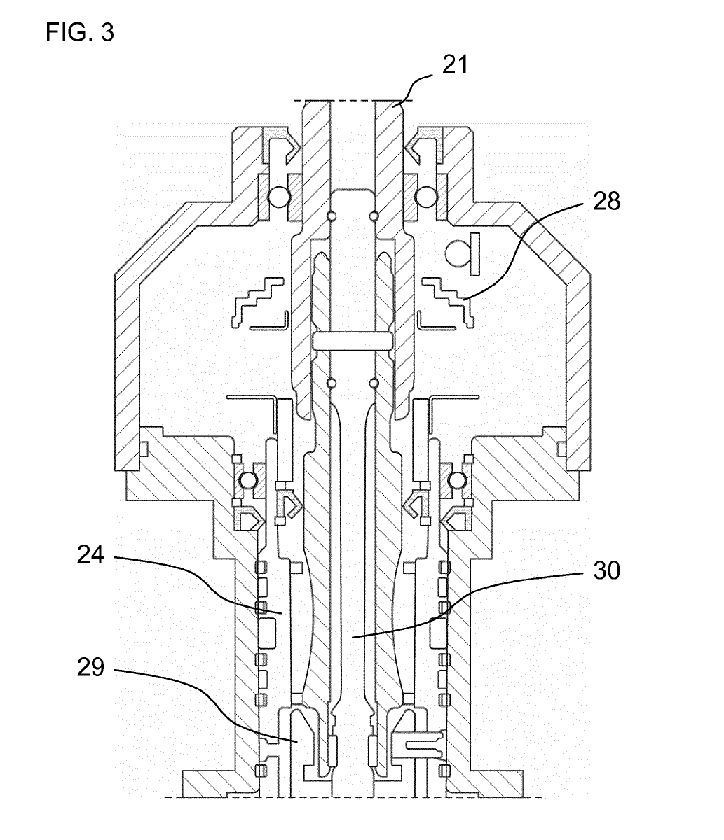

FIG. 3 shows another embodiment, which, among other things, is different due to the use of an inductive sensor 28 for determining the differential angle between the input shaft 21 and the valve sleeve 24.

1. A power steering assembly for a power steering system of motor vehicles, comprising:
an input shaft configured for connection to a steering wheel;
an output shaft coupled to the input shaft configured for operational engagement with a steering rod, wherein the coupling between the input shaft and the output shaft permits a relative rotation therebetween;
a servo controller includes a rotatable control element engaged with the output shaft and driven by the output shaft, wherein the steering power assistance system is controlled depending on the relative rotation between the input shaft and the control element, the engagement between the output shaft and the control element providing for a relative displacement between the two;
an actuator configured for relatively displacing the control element in relation to the output shaft to influence the steering power assistance characteristics;
a sensor system configured for measuring at least one differential angle between the control element and the output shaft or between the control element and the input shaft; and
an evaluation unit for evaluating the measurement values provided by the sensor system.

2. The power steering assembly according to claim 1, further including a steering rod, with a rack-and-pinion gear or a recirculating ball steering gear being provided between the output shaft and the steering rod.

3. The power steering assembly according to claim 1, wherein the actuator is a stepping motor.

4. The power steering assembly according to claim 1, wherein the engagement between the output shaft and the control element includes a multi-stage planetary gear unit.

5. The power steering assembly according to claim 1, wherein the servo controller is a hydraulic servo valve.

6. The power steering assembly according to claim 5, further including a steering-gear housing, wherein the servo valve and the sensor system are accommodated in and/or attached to a valve tower of the steering-gear housing.

7. The power steering assembly according to claim 6, wherein the control element is a valve sleeve disposed coaxially with the input and the output shaft.

8. The power steering assembly according to claim 1, wherein the sensor system includes a differential angle sensor or at least two angle sensors.

9. The power steering assembly according to claim 7, wherein the sensor system includes an encoder sleeve non-rotatably connected to the valve sleeve.

10. Use of the power steering assembly according to claim 1 in a motor vehicle.
